(19) United States
(12) Patent Application Publication
(10) Pub. No.: US 2013/0300866 A1
(43) Pub. Date: Nov. 14, 2013

(54) WIFI PEEPHOLE CAMERA

(71) Applicant: Michael Rogler Kildevaeld, III, Yarmouthport, MA (US)

(72) Inventor: Michael Rogler Kildevaeld, III, Yarmouthport, MA (US)

(21) Appl. No.: 13/940,344

(22) Filed: Jul. 12, 2013

Related U.S. Application Data
(63) Continuation of application No. 13/015,540, filed on Jan. 27, 2011.
(60) Provisional application No. 61/298,730, filed on Jan. 27, 2010.

(51) Int. Cl. H04N 7/18

(52) U.S. Cl. CPC H04N 7/183
USPC 348/143

(57) ABSTRACT

A wireless home security system comprising a camera sized to fit through a conventional door peephole, a camera lens attached to the camera to facilitate capturing an image of the camera field of view, a wi-fi facility for transferring the image to a remote device, and a motion sensor disposed in close proximity to the camera lens for activating the camera and the wi-fi facility in response to detecting a visitor in the camera field of view.

### CROSS-REFERENCE TO RELATED APPLICATIONS

This application is a continuation of U.S. Ser. No. 13/015,540 filed Jan. 27, 2011 which claims the benefit of U.S. provisional application U.S. Ser. No. 61/298,730 filed Jan. 27, 2010, each of which is hereby incorporated by reference in its entirety.

### BACKGROUND

1. Field

The methods, systems, and devices described herein relate to electronic security and in particular to Wi-Fi enabled video security.

2. Description of the Related Art

Security monitoring camera systems typically include a surveillance camera. Wireless home security systems typically include a separate camera and display that is not retrofittable to a conventional door peephole.

### SUMMARY

### Oscillating Sweeper

In an embodiment, the present invention provides an oscillating sweeper that may comprise a plurality of components including a cleaning head, a mop handle, a squirt bottle that may contain a cleaning liquid, a motor, and the like. In an embodiment, the cleaning head may be actuated by the motor and may move rapidly back and forth to provide a scrub like action. In aspect, the motor may be powered by a plurality of rechargeable or non rechargeable alkaline batteries.

In an aspect, the squirt bottle may use the motor, a nozzle and a clutch to periodically squirt the cleaning liquid to the surface to be cleaned.

In an aspect, the cleaning head may be mounted on the mop handle by utilizing a mounting mechanism, for example, by means of screwing, Velcro, pouch, and the like.

In an embodiment, the cleaning head of the sweeper may be reusable or may be required to be changed after using a number of times.

### Wi-Fi Peep Hole Camera

In an embodiment, the present invention describes a door comprising a Wi-Fi peephole system, a Wi-Fi doorbell and speaker system, and a Wi-Fi door handle. The systems described herein may be coupled with each other or may function independently in order to alert a user.

In an embodiment, the Wi-Fi peephole system provided by the present invention may comprise of a camera 302, a camera lens 304, a sensor 308, and a Wi-Fi facility 310. The camera and the camera lens included in the door may be a security camera with a miniature fisheye lens.

In an embodiment, the sensor 308 may be placed near the camera and may be enabled to sense the presence of a visitor in the field of view of the camera. The sensor thereupon may activate the camera 302 and Wi-Fi facility 310. The Wi-Fi facility may be coupled with a remote device such as a PDA, iPhone, Droid, and the like or a Wi-Fi router. Upon activation of the sensor the camera may take a picture of the visitor and same may be then transferred to the remote device via the Wi-Fi facility.

### Wi-Fi Doorbell And Speaker System

In an embodiment, a Wi-Fi doorbell and speaker system may comprise a doorbell, a Wi-Fi facility, a remote device and a speaker. The Wi-Fi facility may be enabled to make a call to the remote device. In an aspect, the Wi-Fi facility may be enabled to communicate with a plurality of remote devices such as a PDA, laptop, home or office computer, and the like in order to alert a user.

### Wi-Fi Door Handle

In an embodiment, the Wi-Fi door handle system may comprise of a digital lock pad and dial pad, a lock, a handle, a sensor, and a key lock. In an aspect, a user may be enabled to unlock the door having the Wi-Fi door handle system by utilizing a device such as a PDA, iPhone, and the like.

In another embodiment, the Wi-Fi door handle may also unlock in case the user himself is in the vicinity of the door locking system.

### Actual GPS

In an embodiment, the present invention provides a navigation system that may comprise a camera and a screen. The camera and the screen may be part of a device or may be separate devices such as an external camera and a smart phone, and the like. The navigation system may display an overlay of directions to a destination and information regarding a roadway over an image of the roadway. The navigation system may also provide information regarding nearest landmarks such as a gas station, restaurant, and the like. The present invention may enable the navigation system to provide information regarding the roadway or the destination such as the distance of the user from a pre set destination, estimated trip time to the pre set destination, and the like. In another embodiment, the navigation system may determine and display a preferred route to the destination according to the present traffic on road, a shorter route to the destination, and the like.

In an embodiment the navigation system may utilize an external camera that may be positioned at different locations within a vehicle to provide different views. For example, an external camera may be positioned at the rear view mirror of a car to provide the images of the traffic behind the car or images of the passengers sitting at the back seat of the car. In an aspect, the external camera may be positioned inside a sphere ball such that the camera may move inside the sphere to certain pre determined positions in order to be pointed towards various locations as desired by the user.

### Earbud Cord Stabilizer

In an embodiment, a weighted device is provided that may comprise a weight and an outer cover. The weight and the outer cover may have a plurality of symmetrical pass through openings to allow a cord of a pair of ear plugs to pass through. The weight may be a metal piece or may be made up of any other similar material providing weight. The outer cover may be made up of rubber, plastic or any other material covers the weight. In an aspect, the plurality of symmetrical pass through openings may be diametrically opposite. The present invention may be utilized with various types of ear plugs or ear phones such as ear plugs that may have a longer right ear cord than the left ear cord and vice versa. In an aspect, when the weighted device is required to be used with ear plugs, the weighted device may be attached to the main cord.

In another embodiment, the earbud cord stabilizer may be utilized with an ear plug or ear phone having a Y style cord. In such a case the earbud cord stabilizer may be attached at the joining of the left and the right cords. In another aspect, the earbud cord stabilizer may also be attached a few inches below the intersection of the left and the right cords.

### BRIEF DESCRIPTION OF THE FIGURES

The invention and the following detailed description of certain embodiments thereof may be understood by reference to the following figures:

FIG. 1 illustrates an oscillating sweeper and its various components in accordance with an embodiment of the present invention;

FIG. 2 illustrates various views of an oscillating sweeper in accordance with an embodiment of the present invention;

FIG. 3 illustrates the lateral movement of the mop handle with respect to the cleaning head.

FIG. 4 illustrates the rapid back and forth movement of the cleaning head.

FIG. 5 illustrates a door comprising a Wi-Fi peephole system in accordance with an embodiment of the present invention;

FIG. 6 illustrates a Wi-Fi doorbell and speaker system in accordance with an embodiment of the present invention;

FIG. 7 illustrates a Wi-Fi door handle system in accordance with an embodiment of the present invention;

FIG. 8 depicts a navigation system in accordance with an embodiment of the present invention;

FIG. 9 illustrates a weighted device and its components in accordance with an embodiment of the present invention;

FIG. 10 shows an outer cover and a weight of the weighted device snapped together with a cord passing through the openings in accordance with an embodiment of the present invention;

FIG. 11 depicts a pair of ear plugs including a weighted device in accordance with an embodiment of the present invention; and

FIG. 12 depicts an application of the earbud cord stabilizer.

### DETAILED DESCRIPTION

### Oscillating Sweeper

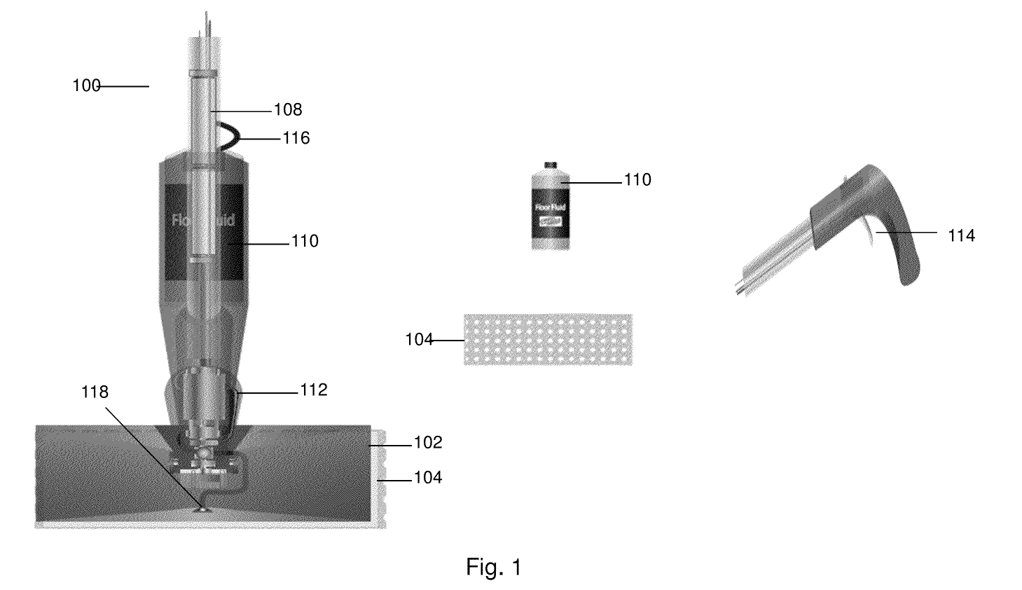

An oscillating sweeper is a cleaning device that may be used for moping, cleaning and/or dusting various surfaces including floors, ground, and the like. FIG. 1 illustrates an oscillating sweeper 100 and a plurality of components that may be included in the oscillating sweeper 100 in accordance with an embodiment of the present invention. The oscillating sweeper 100 may include a cleaning head 102 that may include an absorbent mop 104, a mop handle 108, a squirt bottle 110 containing a floor liquid, a motor 112, a clutch 114, a tube 116, and a nozzle 118. According to various embodiments, the oscillating sweeper may include a mounting mechanism such as screwing, Velcro, pouch, and the like for attaching the cleaning head with the mop handle. The cleaning head 102 of the oscillating sweeper 100 may be activated by the motor 112 to move rapidly back and forth and may provide a scrub like action that may be faster than the motion provided by a human manually.

The squirt bottle 110 may be connected to the nozzle 118 through a tube 116. Further, the nozzle 118 may be placed on the top of the cleaning head 102. In an embodiment, the squirt bottle 110 may be enabled to squirt the cleaning liquid to the surface to be cleaned by using the motor 112, the nozzle 118 and the clutch 114. For example, a user may press the clutch 114 to squirt the floor liquid on the floor to clean the surface. In an aspect, the squirting of floor liquid may be automated such that the floor liquid is squirted periodically on the surface. In an embodiment, the squirt bottle 110 may be reusable, for example, floor liquid may be refilled in the squirt bottle 110 once it is empty. In another aspect, the squirt bottle 110 may not be reusable and it may be required to be replaced with a new squirt bottle once it is empty. The floor liquid contained in the squirt bottle 110 may consist of water, a cleaning additive, and the like. The floor liquid may be used for cleaning purposes or may be used to enhance the cleaning action of the oscillating sweeper 100.

In an embodiment, the absorbent mop 104 may be reusable. In an aspect, the absorbent mop 104 may be made up of materials such as rubber, paper, plastic, and the like. In another aspect, the body of the oscillating sweeper 100 may be made up materials such as of plastic, aluminum and the like. In an embodiment, the various parts of the oscillating sweeper 100 may be made of different materials.

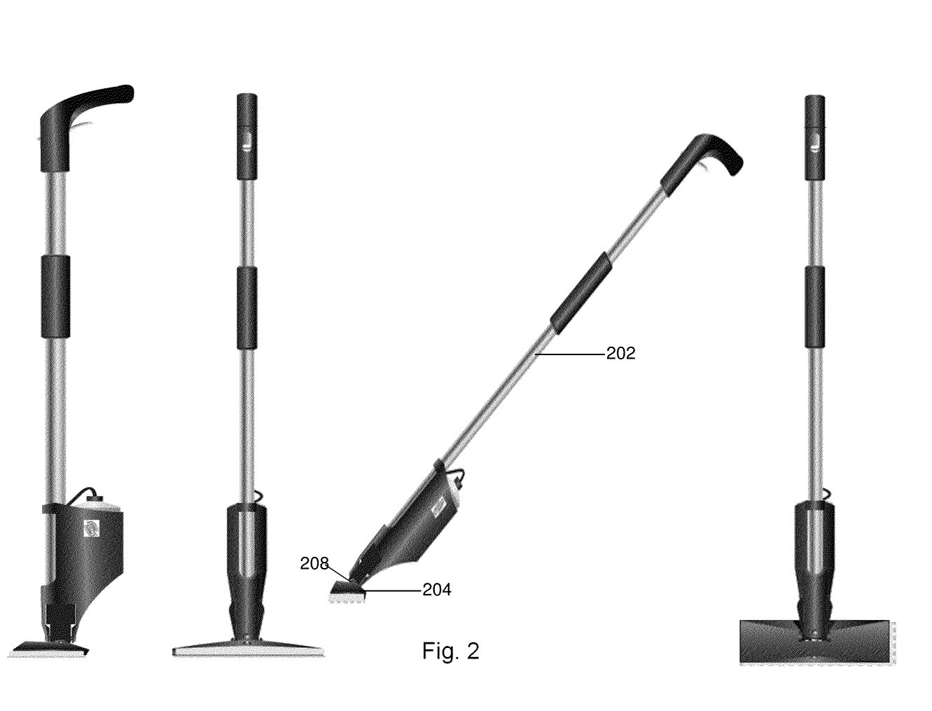

FIG. 2 represents the side and front view of the oscillating sweeper. In an embodiment, the mop handle 202 may be movable at the joining point 208 with respect to the cleaning head 204 such that the mop handle 202 may incline or decline with respect to the cleaning head 204. For example, a user may be able to bend the mop handle 202 to make an acute angle at the joining point 208 of the mop handle and the cleaning head 204.

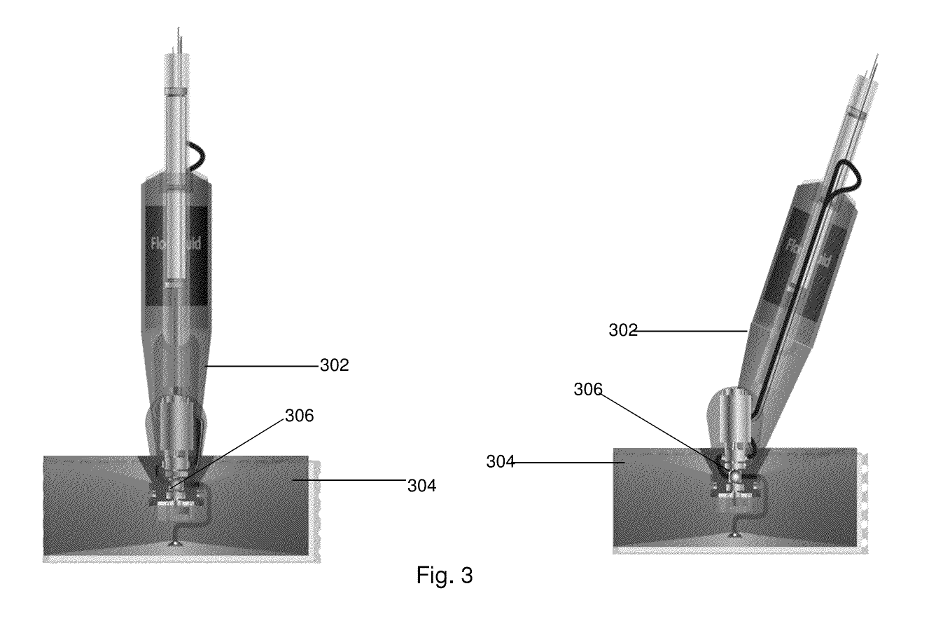

FIG. 3 illustrates movement of the mop handle 302 with respect to the cleaning head 304. In an embodiment, the mop handle 302 may be enabled to move vertically as well as horizontally with respect to the cleaning head 304 at the joining point 308.

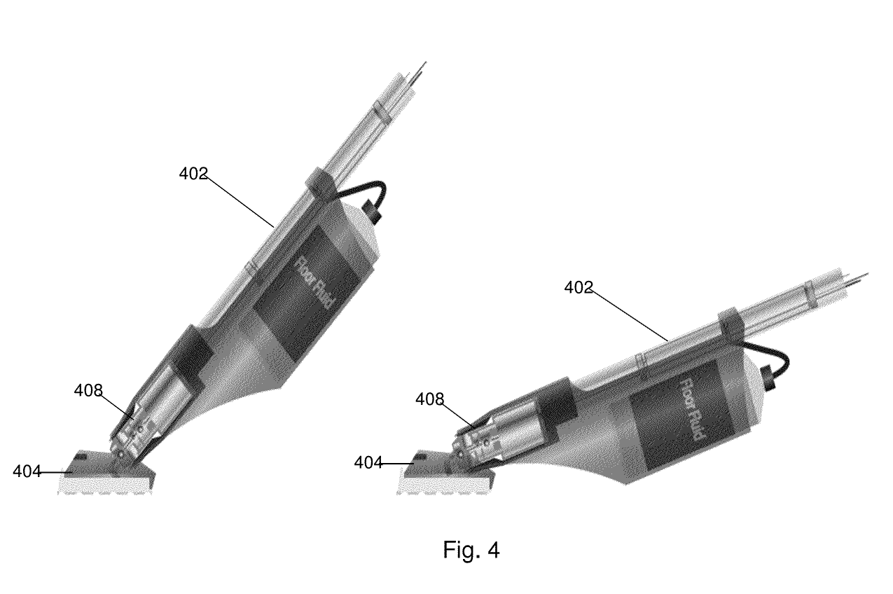

FIG. 4 illustrates the movement and motion of the cleaning head 404. In an embodiment, the cleaning head 404 of the oscillating sweeper 100 may be actuated by the motor 408 and may move rapidly back and forth to provide an action (e.g., scrubbing.) The thrust or force provided by the motor 408 may enable the cleaning head 404 to move faster than possibly achieved by the human force, thereby, enhancing the cleaning efficiency of the oscillating sweeper 100. In another aspect, the motor 408 may be powered by a plurality of rechargeable or non-rechargeable alkaline batteries.

### Wi-Fi Peep Hole Camera

The present invention describes a door comprising a Wi-Fi peephole system, a Wi-Fi doorbell and a speaker system, and a Wi-Fi door handle. The systems described herein may be coupled with each other in order to alert the user about the presence of a visitor at the door. In an embodiment, the Wi-Fi peephole system, the Wi-Fi doorbell and speaker system, and the Wi-Fi door handle may work independent of each other.

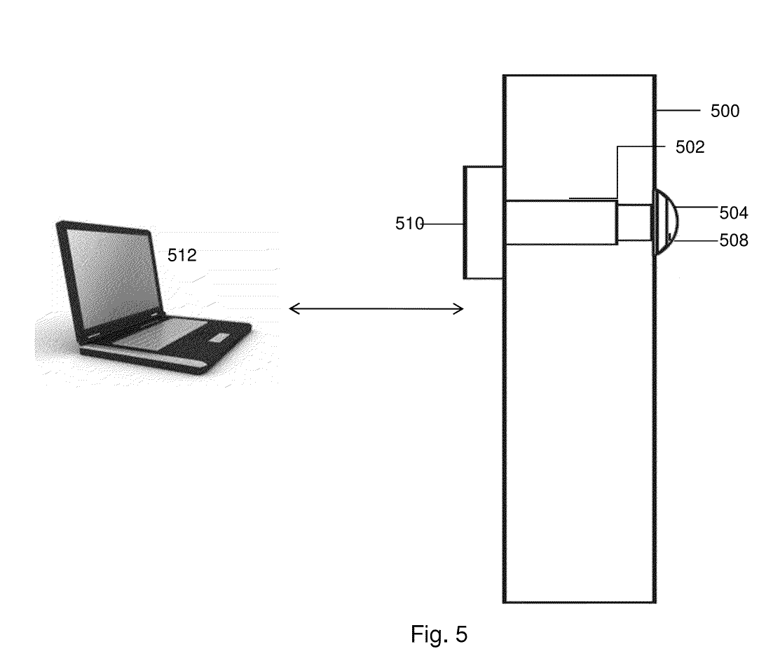

Referring to FIG. 5, a door comprising a Wi-Fi peephole system is illustrated. The door 500 may include a camera 502, a camera lens 504, a sensor 508, and a Wi-Fi facility 510. The door 500 as described by the present invention may also comprise a plurality of other components according to a user's requirement. In addition, the door 500 may be of various types such as a hinged door, sliding door, rotating door, and the like. The Wi-Fi peephole may be controlled with a remote device 512 such as a PDA, mobile phone, smart phone, a Wi-Fi router, modem system, and like. The camera 502 included in the door may be a security camera with a lens 504 such as a miniature fisheye lens, and the like. In an embodiment, the camera lens 504 may be a weather resistant camera lens. In another embodiment, the camera lens 504 may include a camera lens cover.

The Wi-Fi peephole system may be enabled to alert a user in case a visitor comes in proximity of the Wi-Fi peephole system. In an aspect, the sensor 508 may be placed near the camera 502 (reference numeral??). The sensor may be enabled to sense the presence of a visitor in the field of view of the camera and thereupon may activate the camera 502 and Wi-Fi facility 510. Upon activation, the camera 502 may take a picture or make a video of the visitor. The picture or the video may then be transferred to the remote device 512 by the Wi-Fi facility 510. For example, the sensor may be activated once a visitor comes within a distance of 3 meters of the door. The sensor may then activate the camera to take a picture of the visitor and may send the same to the PDA of a user located in a remote location.

In another embodiment, the camera 502 may be enabled to make a video of the field of view that may then be sent to the remote device. For example, a user may be provided a constant view of the field of view of the camera 502 such as the case of a high security area.

### Wi-Fi Doorbell and Speaker System

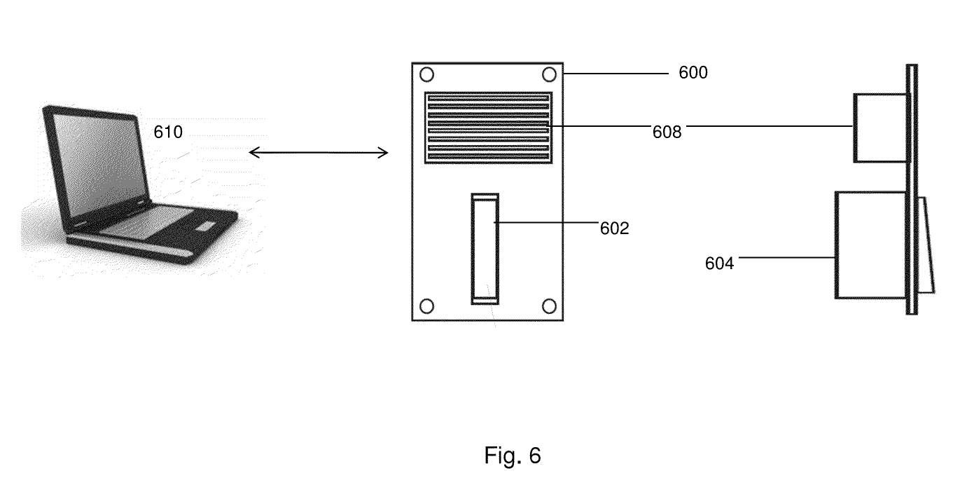

FIG. 6 illustrates a Wi-Fi doorbell and speaker system 600. The Wi-Fi doorbell and speaker system 600 may include a doorbell 602, a Wi-Fi facility 604, and a speaker 608. The Wi-Fi facility may be coupled with a remote device 610 such as PDA, iPhone, Droid, and the like. The Wi-Fi doorbell and speaker system may be enabled to send a doorbell ring to a remote device 610 in order to alert a user in case the doorbell is pressed by a visitor. In an embodiment, The Wi-Fi facility 604 may be enabled to send the doorbell signal to a remote device as a call to a mobile phone that may be answered by the user For example, if a visitor presses the doorbell 602 the Wi-Fi facility 604 may get activated. The Wi-Fi facility may then make a call to the user's phone. The user in turn may answer the call from the Wi-Fi system as a normal phone call.

In another embodiment, the Wi-Fi doorbell and speaker system may provide a facility to have a two way communication with a visitor at the door by utilizing the speaker 608. The Wi-Fi facility 604 may call the user on a remote device 610 when a visitor presses the doorbell 602. The user may attend to the call as a normal phone call and may talk to the visitor on the remote device 610. The visitor in turn may be able to hear the user by on the speaker system 608 and may also reply to the user by utilizing the same speaker system.

### Wi-Fi Door Handle

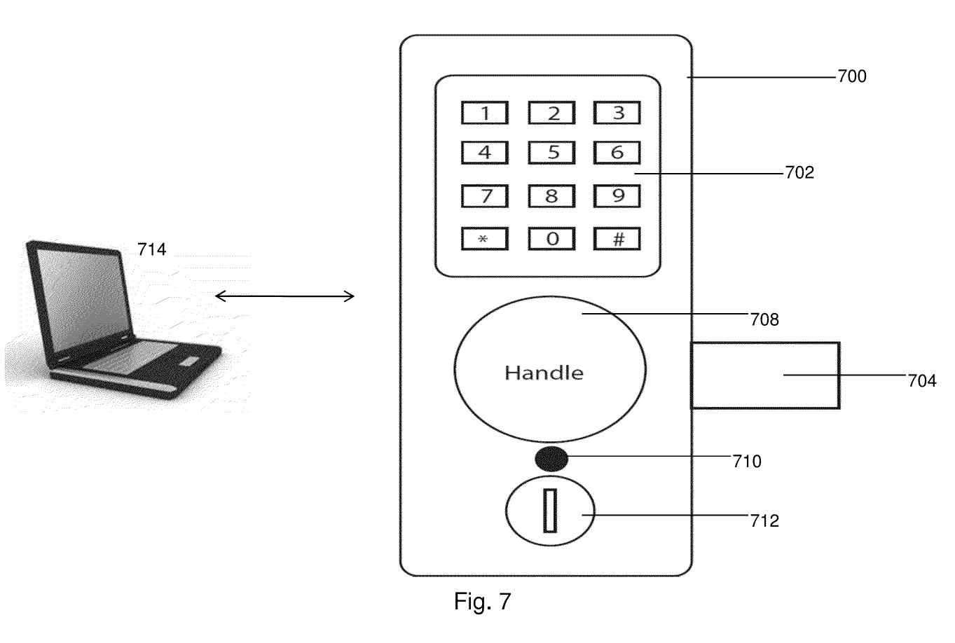

The Wi-Fi door handle system is a digital locking system that may be remotely locked and/or unlocked. FIG. 7 illustrates a Wi-Fi door handle system 700 that may include a digital lock pad and dial pad 702, a lock 704, a handle 708, a sensor 710, a key lock 712, a remote device 714, and a Wi-Fi facility. The Wi-Fi door handle system may enable a user to remotely lock/unlock a lock 704 through a remote device 714. In an embodiment, a user may allow a visitor to open the lock 704 by utilizing the remote device 714 such as a PDA, iPhone, and the like. For example, the user upon confirming the visitor's identity may activate the lock 704 by entering a secret code or confirmation key on the remote device that may allow the visitor to open the door.

In another embodiment, the Wi-Fi door handle may also allow a user to unlock a door in case the user is within a particular range of the door locking system. The sensor 710 may detect the remote device 714 and upon recognizing the authorized remote device may unlock the door. For example, a user standing near the door with his configured mobile phone may be able to unlock the locking system by sending an automatic personal distinct signal via Bluetooth or Wi-Fi with a special software.

In an embodiment, the Wi-Fi door handle may also allow a user to enter a secret code or password by the digital lock pad and dial pad 702. For example, a user without the remote device 714 may be allowed to unlock the door by entering a pre set password.

In another embodiment, the Wi-Fi door handle may allow a user to lock or unlock the door by using a key lock 712. The user may enter a key in the key lock 712 and may open the door by using the handle 708.

### Actual GPS

The present invention describes a navigation system enabling the user to navigate through roadways. The navigation system may be implemented on a device such as a PDA, iPhone, Droid, and the like. The navigation system may utilize the camera of the device in order to display or extract the image of the roadway.

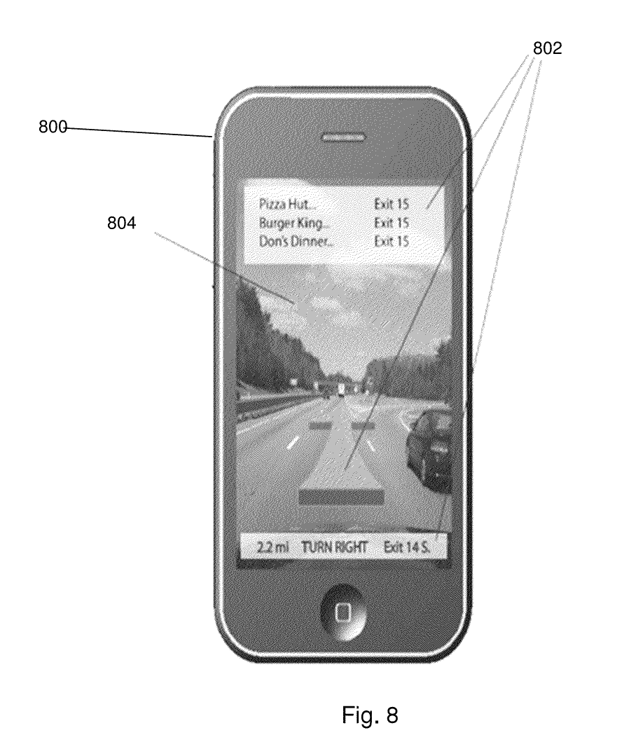

FIG. 8 illustrates an embodiment of the present invention. The navigation system 800 may display an overlay 802 on an image or video of a roadway 804 that may be provided by a camera on a screen such as the screen of a smartphone. The overlay may provide the user with directions by displaying arrows over the image or video of the roadway and/or providing names of the landmarks where next turn may be required to be taken. For example, the user while driving may utilize the navigation system to get directions to a pre-set location. The navigation system may direct the user to the pre-set location by displaying arrows over the image of the roadway. The arrows may be straight arrows guiding the user to drive straight or 90 degree bent arrows guiding the user to take a turn.

The navigation system may be able to determine and display a preferred route to a destination. For example, the navigation system may be enabled to determine a route on which there may be less traffic. In another example, the navigation system may be able to determine a shorter route to the destination.

The navigation system may also provide the user the direction to the next landmark such as a gas station, a restaurant, and the like. For example, the user may require the direction to the next available gas station while reaching a pre-set destination. The navigation system may guide the user to the nearest gas station that may be on the way to the destination.

The navigation system may provide an overlay that may display on the overlay 802 and automatically update the information regarding the destination such as the distance of the user from the destination, countdown to the destination, estimated trip time, arrival time, and the like. For example, the navigation system may be able to display the distance to a destination from the user's current location on the overlay 802 and the distance displayed may decrease as the user comes nearer to the destination.

In an embodiment, the navigation system may utilize external cameras that may be connected to a device such as a smart phone and the like via Bluetooth or Wi-Fi or any other similar technology. Such external cameras may be mounted in various positions in and around a car or any other vehicle to provide different views. For example, external camera may be mounted near rear view mirror to record a video or to provide a view of various locations. In another example, the system may enable a user to view kids sitting at the back seat as the user speaks with them. The device enabled by the present invention may be able to control the external camera to point to various locations. In another example, the navigational system may enable a device to record the journey taken by the user from various angles as the present system is provided with external cameras. Such an external camera may be powered by a battery such as the battery of the car.

In another embodiment, the external camera may be positioned in a sphere ball such that the user may not be able to see the camera. Such a camera may be enabled to travel within the sphere ball to preset locations by a motor system. For example, the camera may be allowed to travel within the sphere to the preset locations in order to view various locations inside as well as outside the car giving the user a 360 degree view of the car surrounding.

### Earbud StayNear

The present invention describes a earbud cord stabilizer to hold cords or cables for ear plugs, ear buds, or ear phones, and the like such that the ear plugs stay in the ear and the cable of the ear plugs does not come in the way of various activities carried out by a user and therefore may help a user lead an active lifestyle. The device may support an earbud set that includes a main cord, a left cord that connects to the left ear bud, and a right cord that connects to the right ear bud. The main cord may be longer and heavier than the other two cords (i.e. left and right cords) and the left cord may be longer than the right cord or vice versa. The main cord may contain a microphone and other controls such as play, pause, answer phone, skip, play back and other features located within easy reach of the user on the main cord. Further, a earbud cord stabilizer may be provided as a counterbalance along with the user's shoulder as a pivoting point to offset the weight of the longer and heavier main cord.

In an embodiment, the earbud cord stabilizer described by the instant invention may be a weighted device that may hold all types of cords of earbuds and earphones in place such that the earbuds are held in the ear and the weighted device may provide stability to the earbud cords. Moreover, the earbud cord stabilizer may also help a user to organize the cord of the earbuds that may prevent the cord from twisting and getting tangled.

The earbud cord stabilizer may act as a weight to counter balance the long thicker and heavier portion of the cord of an earbud, and the like that connects to a music player, cell phone or other hear enabled devices.

The thicker and longer main cable may weigh more than the left and the right ear cables. The large weight difference between the main cable and the left and the right part may tend to pull downward the ear plugs while the user is moving or running when the arms of the user may hit the cable that may in turn pull the ear plugs off. The earbud cord stabilizer may provide an arrangement such that the weight of the heavier cable is managed in such a manner that the ear plugs do not come out of the user's ears.

The present invention may provide an arrangement such that the weight of the cable may go slightly down at the back of the shoulder area and the main cable may be connected to the longer of the two ear cables to act as a counter weight holding the heavier main cable in place. A weight may be provided in the earbud cord stabilizer that may be of a heavy metal, and the like. The earbud cord stabilizer may be a small flat disc or may be of any other shape that may stay smooth in comfort and may have a surface that may stick slightly to the skin or clothing of the user such that the cable does not flip around.

In an aspect, the cable may be placed under the clothes of a user in order to remain stable during a rigorous movement such as running and the like.

The earbud cord stabilizer as described may be built into a cord and may slide along cord or stay fixed on the cord of the earbuds, in-earbuds, ear sound speaker devices and the like.

In an embodiment, the earbud cord stabilizer may also be used for regular ‘Y’ style cord wherein the cord for left and right ear are symmetrical and join at a point to create the main cord that may be thicker than the other two cords as it combines two thin cords. In such a case the earbud cord stabilizer as described in the above paragraphs may be attached to the main cord near the joining of the left and the right cords or a few inches below the intersection of the two thin cords. The user may wear the earbud cord stabilizer inside the shirt. The earbud cord stabilizer may use a shirt collar to hold the weight of the cord and the collar may act as a pivoting point and the earbud cord stabilizer may act as a counterbalance weight. Therefore, the present invention may be utilized for any type of cord.

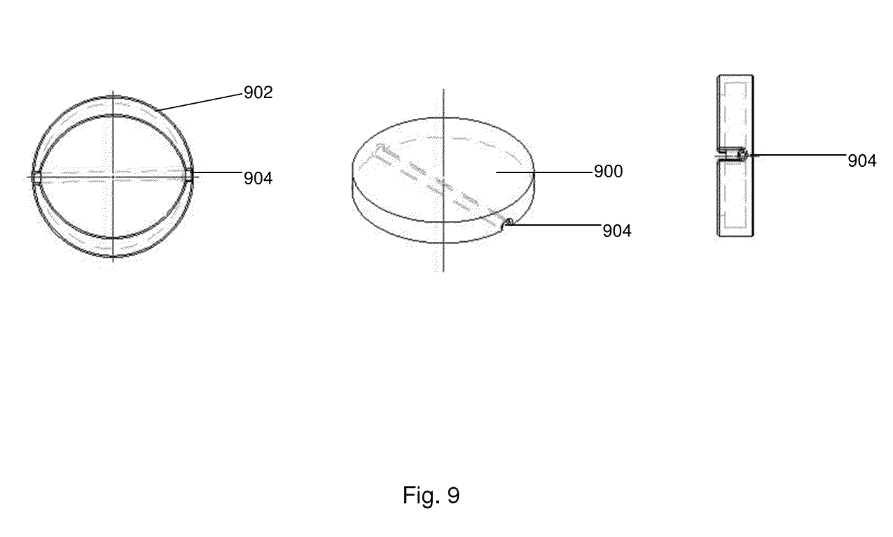

FIG. 9 illustrates an embodiment of the present invention. The figure shows a weight 900 such as brass, steel, and the like that may act as a counter balance. An outer cover 902 has been shown that may be a type of cover over the weight metal. The outer cover 902 may be made of rubber, plastic and the like such that the cover snaps over the weight 900. Both the outer cover and the weight metal contain pass through openings 904 such that the main cord may pass through the grooves of the outer cover into the grooves of the weight metal. Such an arrangement may also slide along the cord in order to adjust the balance of the cord in accordance with user's convenience.

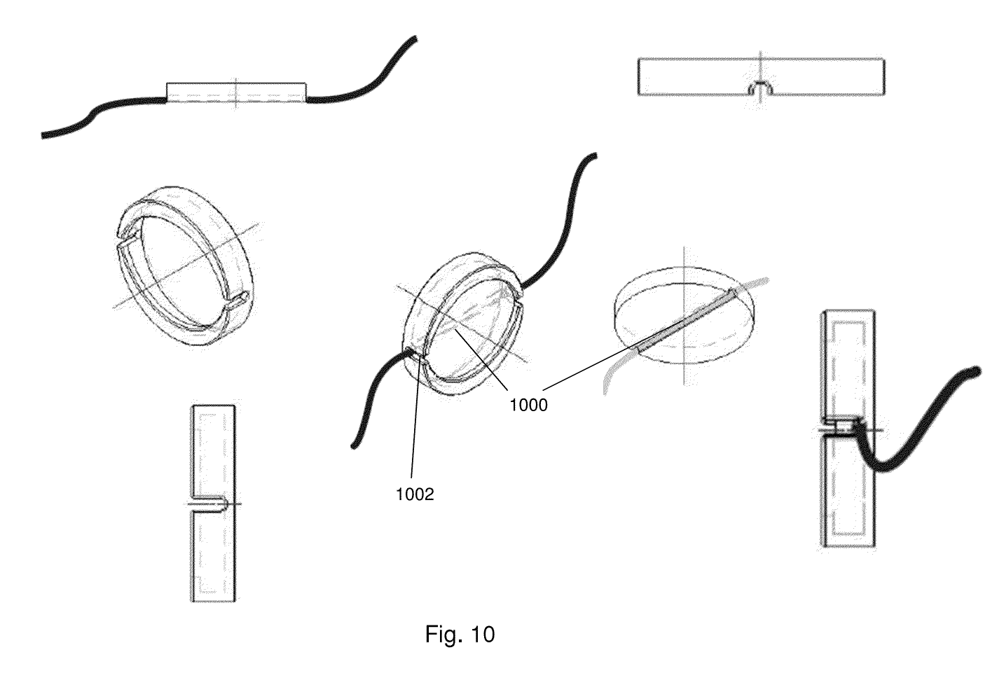

FIG. 10 shows the outer cover and the weight snapped together with the cord wire passing through the openings. Generally, the openings may be diametrically opposite to each other in order to maintain balance.

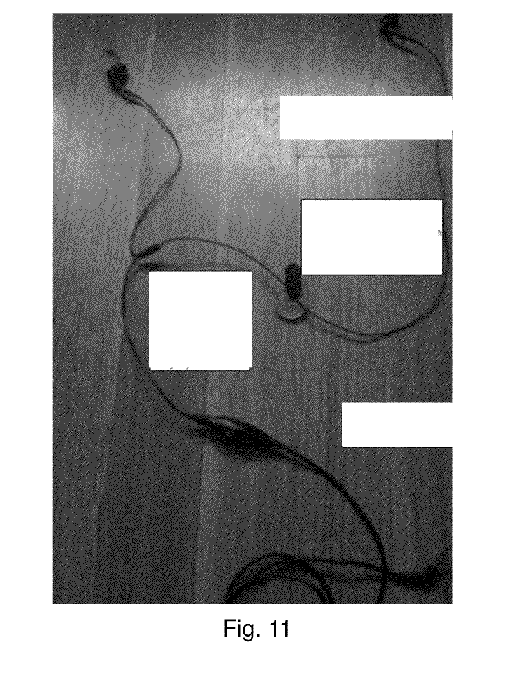

FIG. 11 illustrates a cord having a weighted device in accordance with the present invention.

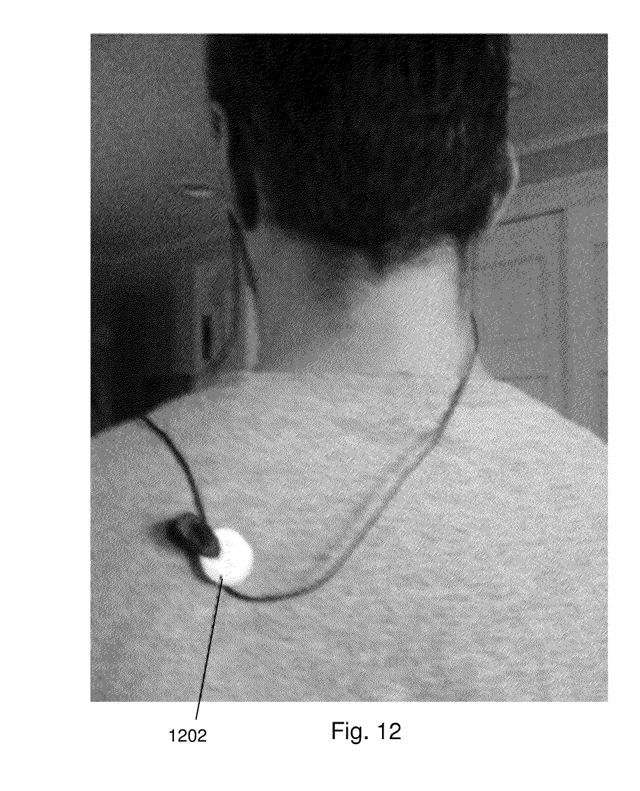

FIG. 12 illustrates an application of the earbud cord stabilizer 1202 on a user.

What is claimed is:

1. An apparatus, comprising:
a camera sized to fit through a conventional door peephole;
a camera lens attached to the camera to facilitate capturing an image of the camera field of view;
a wi-fi facility for transferring the image to a remote device; and
a motion sensor disposed in close proximity to the camera lens for activating the camera and the wi-fi facility in response to detecting a visitor in the camera field of view.

2. The apparatus of claim 1, wherein the remote device comprises one of a smart phone, wi-fi router, personal digital assistant, and mobile phone.

3. The apparatus of claim 1, wherein the camera lens is weather resistant.

4. The apparatus of claim 1, wherein the motion sensor is disposed to detect a visitor in the camera field of view through a portion of the camera lens.

5. The apparatus of claim 1, wherein activating the camera comprises taking a picture of the visitor.

6. The apparatus of claim 5, wherein activating the wi-fi facility comprises sending the picture of the visitor to the remote device.

7. The apparatus of claim 1, wherein activating the camera comprises taking a video of the camera field of view.

8. The apparatus of claim 7, wherein activating the wi-fi facility comprise sending the video to the remote device.

9. The apparatus of claim 1, wherein the camera field of view ranges up to 3 meters from the camera lens.

10. The apparatus of claim 1, wherein the detecting a visitor comprises detecting a visitor up to 3 meters from the camera lens.

11. An apparatus, comprising:
a camera with a portion sized to fit through a conventional door peephole;
an enclosure including a wi-fi facility attached to a first end of the portion for mounting on a first side of a door;
a camera lens attached to a second end of the portion to facilitate capturing content of the camera field of view that is visible from a second side of the door;
the wi-fi facility for transferring the captured content to a remote device; and
a motion sensor disposed in close proximity to the camera lens for activating the camera and the wi-fi facility in response to detecting a visitor in the camera field of view.

12. A method, comprising:
configuring a camera with a portion sized to fit through a conventional door peephole;
attaching a wi-fi facility to a first end of the portion for mounting on a first side of a door, the wi-fi facility for transferring content captured by the camera to a remote device;
attaching a camera lens to a second end of the portion to facilitate capturing content of the camera field of view that is visible from a second side of the door; and
disposing a motion sensor in close proximity to the camera lens for activating the camera and the wi-fi facility in response to detecting a visitor in the camera field of view.
